(19) United States
(12) Patent Application Publication
(10) Pub. No.: US 2005/0286535 A1
(43) Pub. Date: Dec. 29, 2005

(54) Verification of consumer equipment connected to packet networks based on hashing values

(76) Inventors: Edgar Vaughan Shrum JR., Smyrna, GA (US); Jeffrey A. Aaron, Atlanta, GA (US)

Correspondence Address: MYERS BIGEL SIBLEY & SAJOVEC, P.A., P.O. BOX 37428, RALEIGH, NC, 27627, US

(21) Appl. No.: 10/880,249

(22) Filed: Jun. 29, 2004

(51) Int. Cl. H04L 12/28; H04L 12/56

(52) U.S. Cl. 370/395.21

(57) ABSTRACT

Consumer equipment that is connected to a packet switched network is verified, and a Quality of Service for communications therewith are controlled based on the verification. Information is hashed to generate a first hash value. The information in a memory of the consumer equipment is hashed to generate a second hash value. The first hash value and the second hash value are compared to generate a verification indication for the consumer equipment. The Quality of Service for information packets that are communicated with the consumer equipment through the packet switched network is controlled based on the verification indication.

### FIELD OF THE INVENTION

The present invention generally relates to the field of packet switched networks, and more particularly to verification of data in consumer equipment that can communicate through packet switched networks.

### BACKGROUND OF THE INVENTION

The Internet has become a worldwide packet switched network for communicating not just data, such as email and pictures, but also for providing real-time bi-directional voice communications. The Internet includes a worldwide web (WWW) of client-server based facilities on which Web pages and files can reside, as well as clients (Web browsers) that can interface users with the client-server facilities. The topology of the WWW can be described as a network of networks, with providers of network service called Network Service Providers. Servers that provide application-layer services may be described as Application Service Providers. Sometimes a single service provider does both functions within a single business.

In recent years, broadband access technologies have facilitated the communication of voice, video, and data over the Internet and other public and private packet switched networks. Because broadband technologies are typically deployed by a single transport service provider, like a Regional Bell Operating Company (RBOC), their packet switched networks are often shared by many network service providers and application service providers.

Service providers can offer services that range from Internet access and virtual private network access to Voice over IP, Video on Demand, and Gaming. Because such services can have vastly different network resource requirements, some service providers can offer varying levels of Quality of Service (QoS) to subscribers. For example, service providers may allow subscribers to mark their packet communications with a requested QoS level. Such markings may be made by customer equipment that the subscriber uses to interface to a packet switched network. The packet switched network may then, based on the requested QoS level and its presently available resources, increase the communication bandwidth and priority that it uses to communicate that subscriber's packet communications.

### SUMMARY OF THE INVENTION

Some embodiments of the present invention provide methods of verifying consumer equipment that is connected to a packet switched network. Information is hashed to generate a first hash value. The information in a memory of the consumer equipment is hashed to generate a second hash value. The first hash value and the second hash value are compared to generate a verification indication for the consumer equipment. A QoS for information packets that are communicated with the consumer equipment through the packet switched network is controlled based on the verification indication.

Accordingly, the consumer equipment may be verified by repetitively hashing information therein over time to generate hash values, and comparing the hash values to determine whether the information has changed. Changes to the information in the consumer equipment may indicate that the consumer equipment has been improperly modified, such as having been tampered with and/or hacked-into, and/or that it has otherwise become corrupted so that it is no longer trusted to generate valid QoS requests, either explicitly such as by transmitted signals requesting QoS treatment, or implicitly such by special marking(s) applied to the packets normally being communicated. The packet switched network may then deny a QoS request and/or cancel an earlier QoS request from the consumer equipment when such changes are detected.

In some further embodiments of the present invention, generation of the second hash value may be carried out at the consumer equipment, and generation of the first hash value, comparison of the hash values, and controlling QoS may be carried out at the packet switched network. The generation of the first hash value may alternatively be carried out at the consumer equipment.

In some further embodiments of the present invention, the second hash value may be generated based on a verification request from the packet switched network, which may make the request an elapsed time after the first hash value is generated. The elapsed time may be based on whether the information is within a read-only memory or a read-write memory in the consumer equipment, whether the information can be modified by a subscriber, how often the information can change, whether the information contains program operations or data, traffic characteristics of information packets communicated with the consumer equipment, and/or based on a trust profile for the consumer equipment.

In some further embodiments of the present invention, the consumer equipment may hash all or selected portions of its information to generate one or more hash values. Selection of the portion(s) of the information that are to be hashed may be based on whether the selected portion(s) are within a read-only memory or a read-write memory in the consumer equipment, whether they can be modified by a subscriber, how often they can change, whether they contain program operations or data, the identity and/or functionality of a corresponding program, whether they contain one or more specifically identified component functions of a particular program, traffic characteristics of information packets communicated with the consumer equipment, and/or based on a trust profile. The packet switched network may select what portion(s) of the information are to be hashed, and may identify the selected portion(s) of the information with a verification request to the consumer equipment. The consumer equipment may determine what portion(s) of the information are to be hashed, and may identify the selected portion(s) to the packet switched network with the generated hash value(s). Hashing of the information in the consumer equipment may include repetitively hashing nested portions of the information to generate a plurality of hash values.

In some other embodiments of the present invention, a packet switched network includes a verification system that is configured to receive a second hash value from consumer equipment, and to compare the second hash value to a first hash value to generate a verification indication for the consumer equipment. The verification system is also configured to control QoS for communicated information packets that flow to and from the consumer equipment through the packet switched network based on the verification indication. The second hash value is based on a hashing of information in a memory of the consumer equipment.

In some other embodiments of the present invention, consumer equipment includes a memory that is configured to at least temporarily store information, and a controller. The controller is configured to communicate information packets through a packet switched network at a QoS that is defined by the packet switched network, to hash the information in the memory to generate a hash value, and to communicate the hash value to the packet switched network.

Other methods, packet switched networks, consumer equipment and/or computer program products according to embodiments will be or become apparent to one with skill in the art upon review of the following drawings and detailed description. It is intended that all such additional methods, packet switched networks, consumer equipment and/or computer program products be included within this description, be within the scope of the present invention, and be protected by the accompanying claims.

### BRIEF DESCRIPTION OF THE DRAWINGS

FIG. 1 is a block diagram of a communication system and method that verifies consumer equipment and controls quality of service based thereon according to some embodiments of the present invention.

FIG. 2 is a block diagram of another communication system and method that verifies consumer equipment and controls quality of service based thereon according to some other embodiments of the present invention.

FIG. 3 is a block diagram of consumer equipment and method that hashes information to generate hash value(s) that may be used for verification purposes according to various embodiments of the present invention.

FIG. 4 is a flow chart illustrating operations for verifying consumer equipment and for controlling quality of service based on the verification according to some embodiments of the present invention.

### DETAILED DESCRIPTION OF THE INVENTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

It also will be understood that, as used herein, the term “comprising” or “comprises” is open-ended, and includes one or more stated elements, steps and/or functions without precluding one or more unstated elements, steps and/or functions. As used herein the term “and/or” includes any and all combinations of one or more of the associated listed items.

The present invention may be embodied as methods, packet switched networks, and/or consumer equipment. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described below with reference to block diagrams and/or operational illustrations of methods, packet switched networks, and consumer equipment according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

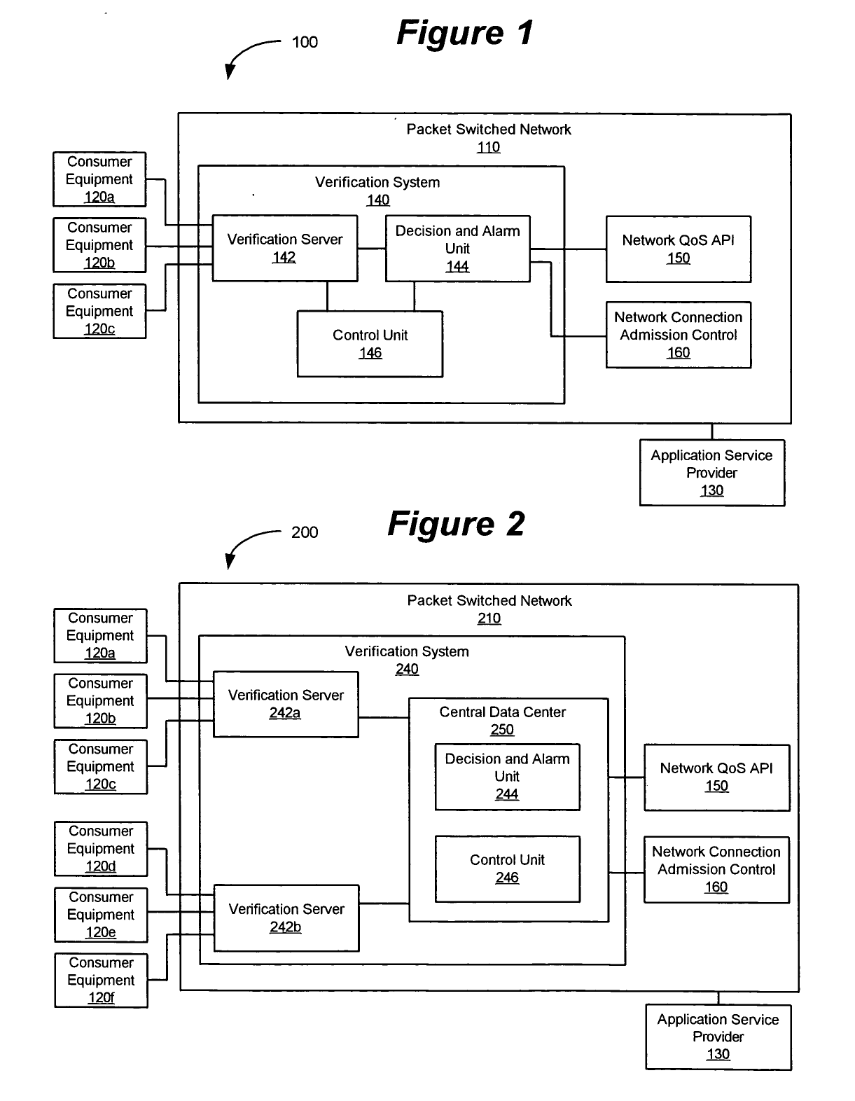

FIG. 1 is a block diagram of a communication system 100 and method that includes a packet switched network 110, consumer equipment 120a-c, and an application service provider 130, such as network infrastructure services including domain name systems (DNS). The packet switched network 110 can route information packets between the consumer equipment 120a-c and application service provider 130, and may route the information packets to various other networks, equipment, and/or service providers. According to some embodiments of the present invention, the packet switched network 110 can include a verification system 140, a network Quality of Service (QoS) application interface (API) 150, and a network connection admission control 160.

As used herein, the term “consumer equipment” includes any device that is configured to communicate information packets with a packet switched network, and includes, but is not limited to, a cable modem, a digital subscriber line modem, a public switched telephone network modem, a wireless local area network modem, a wireless wide area network modem, a computer with a modem, a mobile terminal such as personal data assistant and/or cellular telephone with a modem. For consumer equipment that communicates with a packet network through a wireless interface, the consumer equipment may be configured to communicate via a wireless protocol such as, for example, a cellular protocol (e.g., General Packet Radio System (GPRS), Enhanced Data Rates for Global Evolution (EDGE), Global System for Mobile Communications (GSM), code division multiple access (CDMA), wideband-CDMA, CDMA2000, and/or Universal Mobile Telecommunications System (UMTS)), a wireless local area network protocol (e.g., IEEE 802.11), a Bluetooth protocol, another RF communication protocol, and/or an optical communication protocol.

The consumer equipment 120a-c can request a level of QoS for information packets that are communicated therewith through the packet switched network 110. A QoS request may be communicated from the consumer equipment 120a-c as part of an information packet to the packet switched network 110. A requesting one of the consumer equipment 120a-c may, for example, make a QoS request on its own initiative and/or in response to a request from another one of the consumer equipment 120a-c and/or from an application that is hosted by the application service provider 130. The network QoS API 150 and/or the verification system 140 may evaluate the QoS request, and the network QoS API 150 may allocate a QoS level to information packets that are communicated with the requesting consumer equipment 120a-c.

The packet switched network 110 can include, but is not be limited to, an internet protocol (IP) network or other network in which an IP protocol is used in whole or in part, an Asynchronous Transfer Mode (ATM) network, a Frame Relay network, and/or any other network in which data that is to be communicated is separated into chunks which are communicated separately over the network.

A requested and/or allocated QoS level may correspond to any characteristic relating to how information packets can be communicated through the packet switched network 110. For example, a QoS level may correspond to an allocation of network capacity (e.g., bandwidth), an information delay, a loss rate of information (e.g., error rate), a prioritization of information for communication, and/or a traffic profile. A traffic profile may correspond to performance characteristics such as, for example, long term maximum traffic rate and/or short term burst size, and may vary in a predefined manner over time. The QoS level may be applicable to, for example, any network in which two or more flows, streams, connections, and/or information communications, which may be associated with different end users, compete for resources and are dynamically assigned resources or a particular amount/level of resources via direct QoS requests (e.g., request messages) and/or indirect QoS requests (e.g., data having or containing QoS-related markings).

Communications between the consumer equipment 120a-c, the application service provider 130, and/or an application that is hosted on the application service provider 130, may then be managed based on the allocated QoS level. For example, such communications may be managed so that the rate of communicated information is restricted to no more than an allocated capacity level, so that communication delay is no more than an allocated delay level, so that no more information in a communication is lost than is allowed by an allocated loss rate, so that communications are prioritized based on an allocated prioritization level, and/or so that communications are limited to a predefined traffic profile. The allocated QoS level may also define the size of information packets (e.g., maximum transmission unit size) that are communicated through the packet switched network 110, and/or it may cause a traffic profile to be modified based on the allocated QoS level.

Although FIG. 1 illustrates an exemplary communication system 100, it will be understood that the present invention is not limited to such a configuration, but is intended instead to encompass any configuration capable of carrying out the operations described herein. For example, although only three consumer equipment 120a-c and a single packet switched network 110, verification system 140, network QoS API, and application service provider 130 have been shown for illustration purposes, it will be understood that the packet switched network 110 would generally route information packets among thousands of consumer equipment and numerous application service providers. Moreover, illustrative operation of the packet switched network and consumer equipment are described below with regard to a single one of the consumer equipment 120a for purposes of illustration only, and it is to be understood that such operation may be performed with other of the consumer equipment 120b-c.

The network QoS API 150 is configured to evaluate and/or manage a QoS request based on, for example, resources that are available in the packet switched network 110 and/or based on characteristics that are associated with the requesting consumer equipment 120a. The verification system 140 is configured to verify the consumer equipment 120a, and to either directly or indirectly (e.g., via communicating with network elements that implement QoS treatment) control QoS for information packets communicated with the consumer equipment 120a through the packet network 110 based on the verification.

The network connection admission control 160 may selectively allow and disallow access by the consumer equipment 120a-c to communicate through the packet switched network 110 based on command(s) from the verification system 140 and based on available resources of the packet switched network 110. For example, the verification system 140 can verify information in one or more of the consumer equipment 120a-c, and, based on the verification, can control the network connection admission control 160 to selectively allow and disallow the verified consumer equipment 120a-c to communicate through the packet switched network 110.

Accordingly, in some embodiments of the present invention, the verification system 140 can, based on the verification indication, control Quality of Service (QoS) for information packets communicated with the consumer equipment, through the packet switched network and/or access by the consumer equipment to communicate through the packet switched network. In some further embodiments of the present invention, the verification system 140 controls either Quality of Service (QoS) for information packets communicated with the consumer equipment through the packet switched network or access by the consumer equipment to communicate through the packet switched network based on the verification indication.

As used herein, the term “hash” includes, but is not limited to, a mathematical algorithm or other relationship that is used to relate input information to output information. For example, input information may be hashed by performing an exclusive-OR (XOR) based operation on bytes of the input information to generate a fixed-size output value (e.g., a binary string). Thus, for example, hashing two identical information strings will generate the same hash values, while hashing two non-identical information strings can generate different hash values. Hashing may be carried out using standard cryptographic algorithms where hashing of two identical information strings generates the same hash values, which hashing of two non-identical information strings generates different hash values. Exemplary cryptographic hash algorithms that may be used with some embodiments of the invention include Secure Hash Algorithms (e.g., SHA-1) and/or Message Digest (e.g., MD2, MD4, and MD5) algorithms.

The verification system 140 may verify the consumer equipment 120a by determining whether information in the consumer equipment 120a has changed. Changes to the information in the consumer equipment 120a may indicate that the consumer equipment 120a has been improperly modified, such as having been tampered with and/or hacked-into either directly or via the packet switched network, and/or has otherwise become corrupted, and so that it is no longer trusted to generate valid QoS requests. The verification system 140 may then deny a QoS request or cancel an earlier QoS request from the consumer equipment 120a when such changes are detected.

The consumer equipment 120a may be verified by repetitively hashing information in the consumer equipment 120a over time to generate hash values, and comparing the hash values to generate a verification indication. The comparison may determine whether the hash values have changed over time. The verification system 140 then controls the QoS for information packets based on the verification indications for the consumer equipment 120a.

For example, information in the consumer equipment 120a may be hashed to generate a first hash value. Hashing of the information to generate the first hash value may be carried out by the verification system 140, the consumer equipment 120a, and/or elsewhere, such as by a manufacturer of the consumer equipment 120a. When the first hash value is generated elsewhere than the verification system 140, it is then communicated thereto. The verification system 140 may, for example, generate the first hash value for information and then communicate to the information to the consumer equipment 120a, and/or it may maintain a copy of the information in the consumer equipment 120a from which it can generate the first hash value. The consumer equipment 120a may then hash the information within it to generate a second hash value, and communicate the second hash value to the verification system 140. The verification system 140 compares the first hash value and the second hash value to generate a verification indication for the consumer equipment 120a. For example, the verification indication can be indicative of whether the consumer equipment 120a has been successfully or unsuccessfully verified based on whether the first hash value is the same as the second hash value, or based on another relationship between the first and second hash values.

The verification system 140 and/or the network QoS API may selectively deny QoS requests associated with the consumer equipment 120a based on the verification indication. For example, when the verification indication indicates that the consumer equipment 120a has been successfully verified, QoS requests may be allowed to be evaluated (e.g., based on available network resources) and possibly granted by the network QoS API 150. In contrast, when the verification indication indicates that the consumer equipment 120a has been unsuccessfully verified, QoS requests may not be evaluated or granted by the network QoS API 150.

Hashing the information in the consumer equipment 120a may be carried out based on a verification request from the verification system 140. The verification system 140 may request the consumer equipment 120a to hash all or selected portions of its information to generate one or more hash values after an elapsed time since an earlier hashing of the all or selected portions of the information. The elapsed time may be based on whether the information is within a read-only memory or a read-write memory in the consumer equipment 120a, whether the information can be modified by a subscriber, how often the information can change, whether the information contains program operations or data, whether they contain one or more specifically identified component functions of a particular program, the identity and/or functionality of a corresponding program, traffic characteristics of information packets communicated with the consumer equipment 120a, and/or based on a trust profile for the consumer equipment 120a. The verification system 140 may thereby verify the consumer equipment 120a more or less often based on characteristics of the consumer equipment 120a, a subscriber who is associated with the consumer equipment 120a, and/or characteristics of packet traffic communicated with the consumer equipment 120a.

The traffic characteristics of information packets that the verification system 140 may use to determine when and/or how often to verify the consumer equipment 120a may include determining a number of information packets, a rate of information packets, and/or a change in rate of information packets that are communicated with the consumer equipment 120a. The verification system 140 may use a trust profile or trust indication to determine when and/or how often to verify the consumer equipment 120a. The verification system 140 may generate, and/or receive from elsewhere, the trust profile for the consumer equipment 120a. The trust profile may be, for example, based on credit information that is associated with a subscriber who is associated with the consumer equipment 120a, law enforcement records associated with the subscriber, based on the presence of children in a household of the subscriber, based on ages of children in the household, based on earlier verification indications (e.g., successful verifications and/or unsuccessful verifications) that have been generated for the consumer equipment 120a, and/or based on an identity of the type, manufacturer, and/or model of the consumer equipment 120a.

What portion(s) of the information in the consumer equipment 120a are to be hashed to verify the consumer equipment 120a may be selected based on whether the information, or selected portion(s) thereof, is within a read-only memory or a read-write memory in the consumer equipment 120a, whether it can be modified by a subscriber, how often it can change, whether it contains program operations or data, whether it contains one or more specifically identified component functions of a particular program, the identity and/or functionality of a corresponding program, traffic characteristics of information packets communicated with the consumer equipment 120a, and/or based on the trust profile. The verification system 140 may select what portion(s) of the information are to be hashed, and may identify the selected portion(s) of the information with a verification request. The consumer equipment 120a may alternatively, or additionally, determine what portion(s) of the information are to be hashed based on adaptation to such things as absolute or relative rates of change in various portion(s) of the information to be hashed, and may identify the selected portion(s) to the verification system 140 with the generated hash value(s). Specific determinations based on adaptation may be allowed or disallowed by the verification system 140 in order to minimize the change that a hacker would be able to exploit this capability to subvert the verification process.

When more than one portion of the information is hashed, a hash value may be generated for each portion and communicated to the verification system 140, and/or one or more of the generated hash values may be combined with one or more portions of the information and the combination may then be hashed to generate a hash value (i.e., the hash values may be hashed with one or more selected portions of the information). The hash value(s), however generated, may then be communicated from the consumer equipment 120a to the verification system 140 where they may be compared to other hash value(s) (e.g., previously determined hash value(s)) to generate a verification indication for the consumer equipment 120a.

Hashing of the information in the consumer equipment 120a may include repetitively hashing nested portions of the information to generate a plurality of hash values. Nested hashing may be used, for example, to identify what portion of the information has changed. This could be done by generating first and second hashes of a grouped or collected set of portion(s) of the information, and if any change were noted via differences in the first and second hash values, subsequent checks of subsets of that set could be likewise checked to determine the specific subset containing the change. Further subsets of that subset could then be checked, and so on until the specific portion containing the change is determined. The verification system 140 may then control the QoS based on which portion of the information in the consumer equipment 120a is identified as having changed.

For example, the verification indication generated for the consumer equipment 120a may be based on whether the identified changed portion of the information was expected to have changed, and/or based on whether two or more identified changed portions of the information are expected to change together (e.g., both were expected to have changed, or only one of the two was expected to have changed). Accordingly, the identity of what portion(s) of the information have changed may be used to determine whether the consumer equipment 120a has become unacceptable corrupted.

The consumer equipment 120a may communicate the plurality of hash values generated by nested hashing to the verification system 140, and/or may combine one or more of the hash values with one or more of the nested portions of the information and the combination may then be hashed to generate a combined hash value that may then be communicated to the verification system 140.

As shown in FIG. 1, the verification system 140 can include a verification server 142, a decision and alarm unit 144, and a control unit 146. The control unit 146 may determine when one or more of the consumer equipment 120a-c is to be verified, and may determine what portion(s) of the information in the consumer equipment 120a-c is to be verified, and where such determinations may be based on one or more of the considerations described above. The verification server 142 may generate a verification request to, for example, the consumer equipment 120a based on a command from the control unit 146, and compare the hash value received from the consumer equipment 120a to another hash value (e.g., an earlier hash value) to generate a verification indication. The decision and alarm unit 144 may decide whether the consumer equipment 120a was successfully or unsuccessfully verified based on the verification indication, and the decision may be further based on one or more of characteristics of the information that was hashed and/or based a trust profile that is associated with the consumer equipment 120a, such as described above. The decision and alarm unit 144 can then selectively notify the network QoS API to ignore QoS requests associated with information packets, and/or may generate an alarm notification to, for example, a system operator. The system operator may investigate an unsuccessful verification to, for example, determine whether actions are to be taken with respect to the associated consumer equipment. System operator actions may include contacting a subscriber who is associated with the consumer equipment and/or denying future QoS requests from the consumer equipment.

Referring now to FIG. 2, a block diagram is shown of a communication system 200 that includes the consumer equipment 120a-c, additional consumer equipment 120d-f, the application service provider 130, and a packet switched network 210. The packet switched network 210 includes the network QoS API 150, network connection admission control 160, and a verification system 240. The verification system 240 can include a plurality of verification servers 242a-b and a central data center 250. The central data center 250 may include a decision and alarm unit 244 and a control unit 246. The communication system 200 may operate as was described above for the communication system 100 in FIG. 1, except that more than one verification server 242a-b may be geographically distributed to verify more localized groups of the consumer equipment 120a-f, and the decision and alarm unit 244 and the control unit 246 may be centrally located within the central data center 250. The verification servers 242a-b may be, for example, part of a network server, such as a remote access server (RAS).

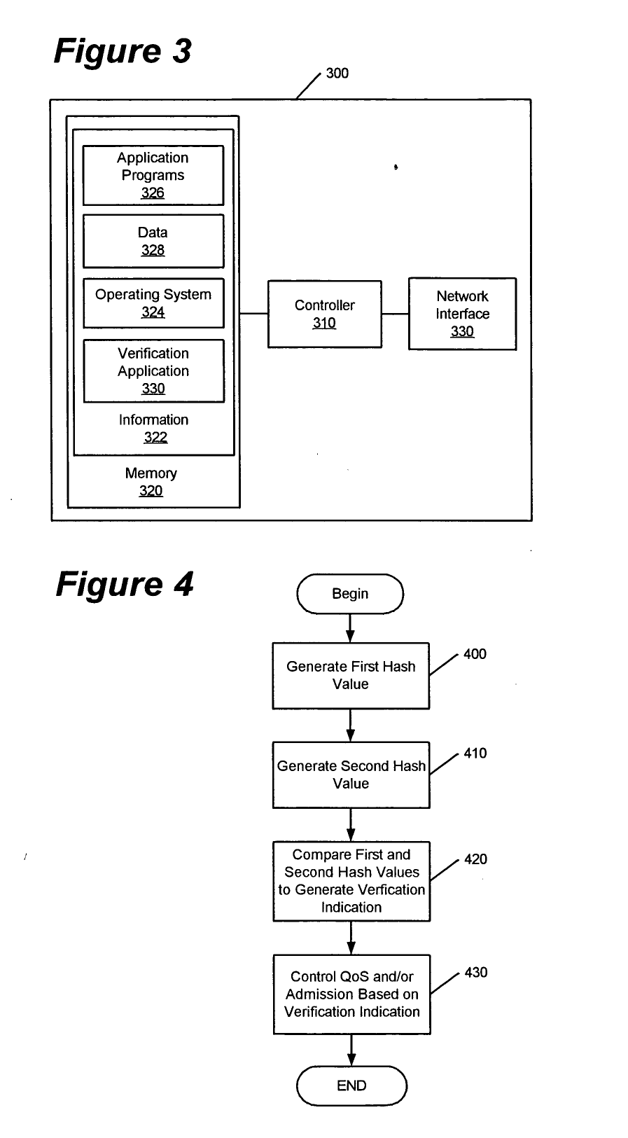

Referring now to FIG. 3, an exemplary consumer equipment 300 is shown. The consumer equipment 300 includes a controller 310, a memory 320, and network interface 330. The memory 320 is representative of the overall hierarchy of memory devices, which can include one or more read-only memories, read-write memories, firmware, flash memory, disk drives, file systems, removable drives and/or other devices that are configured to retrievably store information. Such memory 320 containing the information 322 used to implement the functionality of the consumer equipment 300. As shown in FIG. 3, the memory 320 may include several categories of the information 322 used in the consumer equipment 300: an operating system 324, application programs 326, data 328, and a verification application 330.

As will be appreciated by those of skill in the art, the operating system 324 may be any operating system suitable for operating consumer equipment, and may include, but not be limited to, Cisco IOS, VxWorks, various proprietary modem operating systems, Windows95, Windows98, Windows2000, WindowsXP, Windows CE, Unix, Linux, PalmOS, and/or Java. The application programs 326 and data 328 are illustrative of the programs and related data that implement various features of the consumer equipment 300, including communicating information packets via the controller 310 through the network interface 330 to a packet switched network. The verification application 330 supports operations for verifying the consumer equipment 300, including hashing one or more portions of the information 322, according to embodiments of the present invention.

The controller 310, through the verification application 330, is configured to hash one or more portions of the information 332 to generate a hash value, and to communicate the hash value via the network interface 330 to a packet switched network. The controller 310 may carry out the hashing based on a verification request that is received from a packet switched network.

The controller 310 may repetitively hash the information 332 as was previously described, and the hashing may include repetitively hashing nested portions of the information 332 to identify a portion of the information 332 that has changed from an earlier hash. For example, the a first set of the information 322 can be hashed to generate a hash value for the first set. The hash value for the first set can be compared with a known hash value for the first set (i.e., by the consumer equipment 300 and/or the verification server 140 in FIG. 1). When a difference exists between the hash value for the first set and an earlier hash value, a first subset of the first set may then be hashed to generate a hash value for the first subset. The hash value for the first subset can be compared to a known hash value for the first subset to determine whether the first subset has changed. In this manner, further subset may be hashed and compared to more particularly identify what portion of the information 322 has changed.

Referring now to FIG. 4, a flow chart is shown that illustrates operations for verifying consumer equipment. At Block 400, information is hashed to generate a first hash value. At Block 410, information in a memory of consumer equipment is hashed to generate a second hash value. At Block 420, the first hash value is compared to the second hash value to generate a verification indication. At Block 430, based on the verification indication, QoS is controlled for information packets communicated with the consumer equipment (i.e., communicated to and/or from the consumer equipment) and/or and access by the consumer equipment to communicate through the packet switched network is controlled.

In the drawings and specification, there have been disclosed typical preferred embodiments of the invention and, although specific terms are employed, they are used in a generic and descriptive sense only and not for purposes of limitation, the scope of the invention being set forth in the following claims.

1. A method of verifying consumer equipment connected to a packet switched network, the method comprising:
first hashing information to generate a first hash value;
second hashing the information in a memory of the consumer equipment to generate a second hash value;
comparing the first hash value and the second hash value to generate a verification indication for the consumer equipment; and
controlling based on the verification indication at least one of Quality of Service (QoS) for information packets communicated with the consumer equipment through the packet switched network and access by the consumer equipment to communicate through the packet switched network.

2. The method of claim 1, wherein controlling at least one of Quality of Service (QoS) and access by the consumer equipment comprises controlling Quality of Service (QoS) for information packets communicated with the consumer equipment through the packet switched network.

3. The method of claim 1, wherein controlling at least one of Quality of Service (QoS) and access by the consumer equipment comprises controlling access by the consumer equipment to communicate through the packet switched network.

4. The method of claim 1, wherein controlling Quality of Service (QoS) for information packets communicated with the consumer equipment through the packet switched network comprises selectively denying QoS requests associated with information packets from the consumer equipment based on the verification indication.

5. The method of claim 4, further comprising carrying out at a network QoS application interface (API) the selectively denying QoS requests associated with information packets from the consumer equipment based on the verification indication.

6. The method of claim 1, further comprising:
carrying out at the consumer equipment the second hashing of the information; and
carrying out at the packet switched network the first hashing of the information and the comparing the first hash value and the second hash value to generate a verification indication for the consumer equipment.

7. The method of claim 1, wherein the first hashing of the information comprises:
carrying out the first hashing of the information at the packet switched network to generate the first hash value; and
loading the information into the memory of the consumer equipment.

8. The method of claim 1, further comprising:
carrying out at the consumer equipment the first hashing of the information and the second hashing of the information; and
carrying out at the packet switched network the comparing the first hash value and the second hash value to generate a verification indication for the consumer equipment.

9. The method of claim 1, wherein the second hashing of the information is carried out at the consumer equipment based on a verification request from the packet switched network.

10. The method of claim 9, where the second hashing of the information is carried out an elapsed time after the first verification value is generated, wherein the elapsed time is based on whether the memory is a read-only memory or a read-write memory.

11. The method of claim 9, where the second hashing of the information is carried out an elapsed time after the first verification value is generated, wherein the elapsed time is based on whether the information can be modified by a subscriber.

12. The method of claim 1, wherein the second hashing of the information is carried out an elapsed time after the first verification value is generated, wherein the elapsed time is based on how often the information can change.

13. The method of claim 1, wherein the second hashing of the information is carried out an elapsed time after the first verification value is generated, wherein the elapsed time is based on whether the information contains program operations or data.

14. The method of claim 1, wherein the second hashing of the information is carried out an elapsed time after the first verification value is generated, wherein the elapsed time is based on traffic characteristics of information packets communicated with the consumer equipment.

15. The method of claim 1, further comprising generating a trust profile for the consumer equipment, wherein the second hashing of the information is carried out an elapsed time after the first verification value is generated, and wherein the elapsed time is based on the trust profile.

16. The method of claim 15, wherein generating a trust profile for the consumer equipment comprises generating the trust profile based on at least one of credit information associated with a subscriber who is associated with the consumer equipment, law enforcement records associated with the subscriber, presence of children in a household of the subscriber, ages of children in the household of the subscriber, earlier verification indications generated for the consumer equipment, and an identity of the type, manufacturer, and/or model of the consumer equipment.

17. The method of claim 1, further comprising selecting at least one portion of the information in the memory to be hashed and verified based on at least one of whether the memory is a read-only memory or a read-write memory, whether the portion of the information can be modified by a subscriber, and how often the portion of the information can change, whether the portion of the information contains program operations or data, whether the portion of the information contains one or more predetermined component functions of a predetermined program, an identity and/or functionality of a corresponding program, traffic characteristics of information packets communicated with the consumer equipment, and wherein:
the first hashing comprises hashing the selected at least one portion of the information in the memory; and
the second hashing comprises hashing the selected at least one portion of the information in the memory.

18. The method of claim 1, wherein at least one of the first hashing the information and the second hashing the information comprises:
repetitively hashing nested portions of the information to generate a plurality of hash values, wherein the nested portions of the information at least partially overlap.

19. The method of claim 18, further comprising identifying a portion of the information that has changed based on the plurality of hash values, and wherein controlling Quality of Service (QoS) for information packets communicated with the consumer equipment through the packet switched network is based on the identified portion of the information that has changed.

20. A packet switched network comprising:
a verification system that is configured to receive a second hash value from a consumer equipment, wherein the second hash value is based on a hashing of information in a memory of the consumer equipment; configured to compare the second hash value to a first hash value to generate a verification indication for the consumer equipment, and configured to control based on the verification indication at least one of Quality of Service (QoS) for information packets communicated with the consumer equipment through the packet switched network and access by the consumer equipment to communicate through the packet switched network.

21. The packet switched network of claim 20, wherein the verification system is configured to selectively deny QoS requests associated with information packets from the consumer equipment based on the verification indication.

22. The packet switched network of claim 21, further comprising a network QoS application interface (API), wherein the verification system is configured to control the network QoS API to selectively deny QoS requests associated with information packets from the consumer equipment.

23. The packet switched network of claim 20, wherein the verification system is configured to hash the information to generate the first hash value, and configured to communicate the information to the consumer equipment for loading into the memory.

24. The packet switched network of claim 20, wherein the verification system is configured to request the second hash value from the consumer equipment.

25. The packet switched network of claim 24, wherein the verification system is configured to request a third hash value an elapsed time after requesting the second hash value, wherein the elapsed time is based on at least one of whether the memory is a read-only memory or a read-write memory, whether the information can be modified by a subscriber, how often the information can change, whether the information contains program operations or data, an identity and/or functionality of a corresponding program, traffic characteristics of information packets communicated with the consumer equipment.

26. The packet switched network of claim 24, wherein the verification system is configured to generate a trust profile for the consumer equipment, wherein the trust profile is based on at least one of credit information associated with a subscriber who is associated with the consumer equipment, presence of children in a household of the subscriber, ages of children in the household of the subscriber, earlier verification indications generated for the consumer equipment, and the verification system is configured to request a third hash value an elapsed time after requesting the second hash value, wherein the elapsed time is based on the trust profile.

27. The packet switched network of claim 24, wherein the request from the verification system requests that the consumer equipment hash at least one selected portion of the information in the memory of the consumer equipment to generate the second hash value, wherein the selected portion of the information is based on at least one of whether the memory is a read-only memory or a read-write memory, whether the portion of the information contains one or more predetermined component functions of a predetermined program, whether the portion of the information can be modified by a subscriber, how often the portion of the information can change, whether the portion of the information contains application program operations or data, an identity and/or functionality of a corresponding program, traffic characteristics of information packets communicated with the consumer equipment.

28. Consumer equipment comprising:
a memory that is configured to at least temporarily store information; and
a controller that is configured to communicate information packets through a packet switched network at a Quality of Service (QoS) that is defined by the packet switched network, configured to hash the information in the memory to generate a hash value, and configured to communicate the hash value to the packet switched network.

29. The consumer equipment of claim 28, wherein the controller is configured to hash the information in the memory based on a verification request from the packet switched network.

30. The consumer equipment of claim 28, wherein the controller is configured to repetitively hash nested portions of the information in the memory to identify a portion of the information that has changed.
